(19) United States
(12) Patent Application Publication
(10) Pub. No.: US 2026/0219353 A1
(43) Pub. Date: Jul. 30, 2026

(54) CALIBRATION FOR WIRELESS DISTANCE ESTIMATION

(71) Applicant: QUALCOMM Incorporated, San Diego, CA (US)

(72) Inventors: Mahmoud Munsaf M BADI, San Jose, CA (US); Rishabh RAJ, Jamshedpur (IN); Xiaoxin ZHANG, Sunnyvale, CA (US); Abhinav KUMAR, Sasaram (IN); Mani Krishnan VENKATACHARI, Chennai (IN); Madhanagopalan SAMBATH KUMAR, Chennai (IN)

(21) Appl. No.: 19/038,625

(22) Filed: Jan. 27, 2025

(51) Int. Cl. G01S 5/02

(52) U.S. Cl. CPC G01S 5/021; G01S 5/0242; G01S 5/0284

(57) ABSTRACT

Methods and apparatus for calibrating distance estimation with a target wireless device using a measuring wireless device are disclosed. In some embodiments, a method of calibrating distance estimation with a target wireless device using a measuring wireless device may include: while the target wireless device is determined to be at a fixed position relative to the measuring wireless device: sending a first wireless signal to the target wireless device, and receiving a second wireless signal from the target wireless device; measuring a round trip time to the target wireless device based on the first wireless signal and the second wireless signal; estimating an error associated with the round trip time to the target wireless device based at least on the round trip time to the target wireless device; and calibrating the measuring of the round trip time to the target wireless device using the estimated error.

### BACKGROUND

### 1. Field of Disclosure

The present disclosure relates generally to the field of wireless communications, and more specifically to e.g., calibrating distance estimation between wireless-enabled devices using radio frequency (RF) signals.

### 2. Description of Related Art

Location features are becoming increasingly important in wireless-enabled devices. For example, location features using Round Trip Time (RTT) is or will be mandatory in certain Wi-Fi standards (such as Wi-Fi 8). RTT is a technique used with devices having RTT capabilities to measure a distance to other devices supporting such capabilities. RTT calibration is performed to determine distances to objects and other devices precisely, and can also be used to determine the location (e.g., an indoor location) of a measuring device, which can be used in other applications such as location-based automation.

### BRIEF SUMMARY

In some aspects of the present disclosure, a method of calibrating distance estimation with a target wireless device using a measuring wireless device is disclosed. In some embodiments, the method may include: while the target wireless device is determined to be at a fixed position relative to the measuring wireless device, sending a first wireless signal to the target wireless device, and receiving a second wireless signal from the target wireless device; measuring a round trip time to the target wireless device based on the first wireless signal and the second wireless signal; estimating an error associated with the round trip time to the target wireless device based at least on the round trip time to the target wireless device; and calibrating the measuring of the round trip time to the target wireless device using the estimated error.

In some implementations thereof, the target wireless device may be determined to be at the fixed position relative to the measuring wireless device based on a user calibration request at the measuring wireless device, inertial data of the measuring wireless device, sensed indication of the target wireless device, or a combination thereof.

In some embodiments, the method may include: while the target wireless device is determined to be at a fixed position relative to the measuring wireless device, sending a first radio frequency (RF) signal to a reference object proximate the target wireless device, and receiving a second RF signal reflected from the reference object; measuring a round trip time to the reference object based on the first RF signal and the second RF signal; while the target wireless device is at the fixed position, sending a first wireless signal to the target wireless device, and receiving a second wireless signal from the target wireless device; measuring a round trip time to the target wireless device based on the first wireless signal and the second wireless signal; estimating an error associated with the round trip time to the target wireless device based on the round trip time to the target wireless device and the round trip time to the reference object; and calibrating the measuring of the round trip time to the target wireless device using the estimated error.

In some aspects of the present disclosure, a wireless device is disclosed. In some embodiments, the wireless device may include: one or more transceivers; one or more memories; and one or more processors communicatively coupled with the one or more transceivers and the one or more memories, wherein the one or more processors are configured to: while a target wireless device is determined to be at a fixed position relative to the wireless device, send a first wireless signal to the target wireless device, and receive a second wireless signal from the target wireless device; measure a round trip time to the target wireless device based on the first wireless signal and the second wireless signal; estimate an error associated with the round trip time to the target wireless device based at least on the round trip time to the target wireless device; and calibrate the measurement of the round trip time to the target wireless device using the estimated error.

In some aspects of the present disclosure, a computer-readable apparatus is disclosed. In some embodiments, the computer-readable apparatus may include a storage medium having instructions configured to, when executed by one or more processors, cause a measuring wireless device to: while a target wireless device is determined to be at a fixed position relative to the measuring wireless device, send a first wireless signal to the target wireless device, and receive a second wireless signal from the target wireless device; measure a round trip time to the target wireless device based on the first wireless signal and the second wireless signal; estimate an error associated with the round trip time to the target wireless device based at least on the round trip time to the target wireless device; and calibrate the measurement of the round trip time to the target wireless device using the estimated error.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of a radio frequency (RF) sensing system.

FIGS. 4A-4D are diagrams of sequences illustrating examples of Round Trip Time (RTT) measurements between two wireless devices.

FIG. 5 is a diagram showing an example approach to RTT calibration between two wireless devices, according to some embodiments.

FIG. 6 is a diagram showing another example approach to RTT calibration between two wireless devices, according to some embodiments.

FIGS. 7A and 7B show views of another example approach to RTT calibration between two wireless devices, according to some embodiments.

FIG. 8 is a flow diagram of a method of calibrating distance estimation with a target wireless device, according to some embodiments.

FIG. 9 is a flow diagram of another method of calibrating distance estimation with a target wireless device, according to some embodiments.

FIG. 10 is a flow diagram of another method of calibrating distance estimation with a target wireless device, according to some embodiments.

FIG. 11 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may mean absolute location determination, relative location determination, ranging, or a combination thereof. Such positioning may include and/or be based on timing, angular, phase, or power measurements, or a combination thereof (which may include RF sensing measurements) for the purpose of location or sensing services.

Round Trip Time (RTT) is a technique that may be used by a device to estimate a distance to a target object (including another device supporting RTT) based on the time it takes for a signal to reach the target object and report back. One or more RTT measurements may be taken using one or more antennas to estimate the distance. Various types of devices may be capable of performing RTT, including mobile user devices (e.g., smartphones, UEs), and Internet of Things (IoT) devices and RF devices, e.g., Wi-Fi routers, Bluetooth devices, and tracking tags.

RTT depends on precise delay calibration to function reliably. For Wi-Fi, a considerable amount of time and resources are dedicated to RTT calibration for each wireless interface chip. RTT calibration is traditionally performed using either a calibrated cabled setup, where the latency introduced by the cables is known, or over-the-air (OTA) tests at locations with known distances. Both methods require specialized test equipment and environments, making it challenging for end users to perform RTT calibration.

Moreover, traditional RTT calibration can include testing all possible modes and configurations, involving hundreds of test cases. Limited or prioritized resources may result in inability to complete full RTT calibration. As a result, retailers and users of devices may handle RTT calibration for modes not calibrated by a manufacturer. Additionally, even for modes that have been calibrated, users may need to redo RTT calibration to account for additional analog delay introduced by customized device designs. Significant effort required to perform such calibration has resulted in users not completing full RTT calibration. Hence, the majority of billions of devices with RTT capabilities remain uncalibrated.

Various components (e.g., analog components, filters, digital processing) of a device and their configurations can introduce extra delays. Time delays can introduce additional errors to estimates (e.g., increasing the possible range of estimation). For instance, even two to three nanoseconds of delay can introduce a meter of error. Introducing or removing new components, or changing the design of a chip, may also cause the delay measured to be different.

Proximity ranging and direction finding over Wi-Fi and/or future wireless standards may become a ubiquitous feature in an increasing number of devices. Hence, calibrating distance estimation is becoming increasingly important in user devices. To these ends, mechanisms that enable end users to perform RTT calibration and improve distance estimation accuracy and precision without requiring specialized test equipment or environments are desirable. For example, in some cases, such calibration mechanisms may be implemented in or guided in a streamlined fashion (e.g., with a user application (app)) to allow ease of use and increases user compliance.

Various aspects relate generally to obtaining a distance and calibrating RTT measurement using the distance. In some embodiments of the present disclosure, radio frequency (RF) sensing can be used to reduce the error in RTT calibration. More specifically, a monostatic RF sensing system can be used to send an RF signal toward a reference object (e.g., surface of wall) near a target device. The time duration between sending the RF signal and receiving a reflected signal can be used to estimate the error or bias when performing RTT with the target device. This resulting error can then be used calibrate the RTT to the target device. In some implementations, the above approach can be set up by a user, for example, by securing the target device against the wall and holding the measuring device at the same height, while following steps provided by an app on the measuring device.

In some embodiments, the measuring device and the target device may be placed at a known distance apart, e.g., on a table. The error associated with RTT may be calibrated using the known distance.

In some embodiments, imaging processes may be used to estimate the distance between devices, for example, using image data from a camera of the measuring device. RTT may then be calibrated using the image-based distance estimation.

Particular aspects of the subject matter described in this disclosure can be implemented to realize one or more of the following potential advantages. In some examples, the described techniques may be used by users to perform RTT calibration to enhance the distance estimation of a device, including ad hoc calibration in non-specialized environments, such as on a flat wall or table. The described techniques can be used to enable end users to perform desirable RTT calibrations on uncalibrated devices already in the market. That is, calibration need not be performed during manufacture or before market. These approaches eliminate the need for specialized test equipment and environments, making RTT calibration accessible to end users without expertise, and ultimately improving distance estimation using. This is useful for wireless standards that is or will become used by devices, such as Wi-Fi RTT, which is a mandatory part of some Wi-Fi specifications.

Additional details will follow after an initial description of relevant systems and technologies.

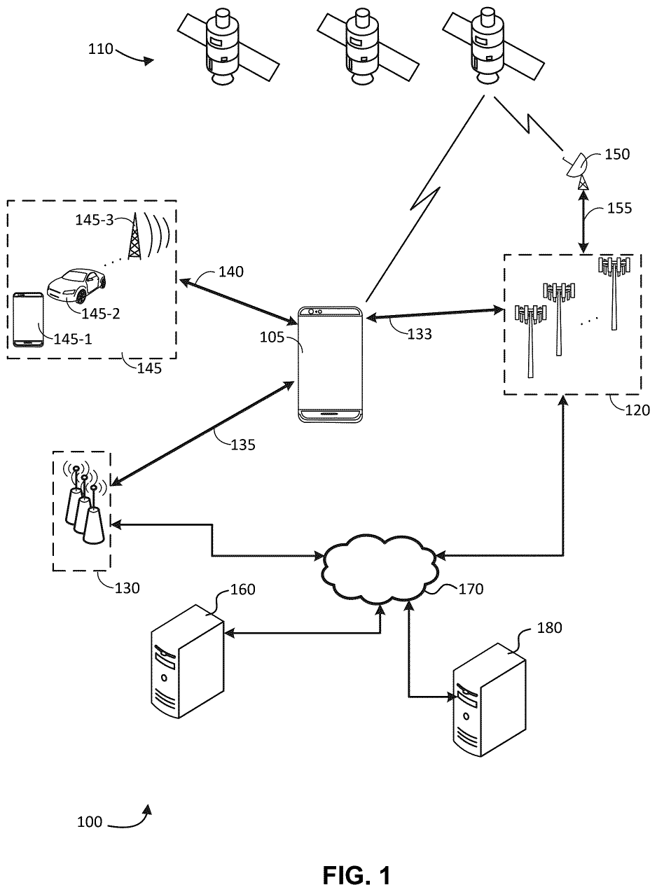

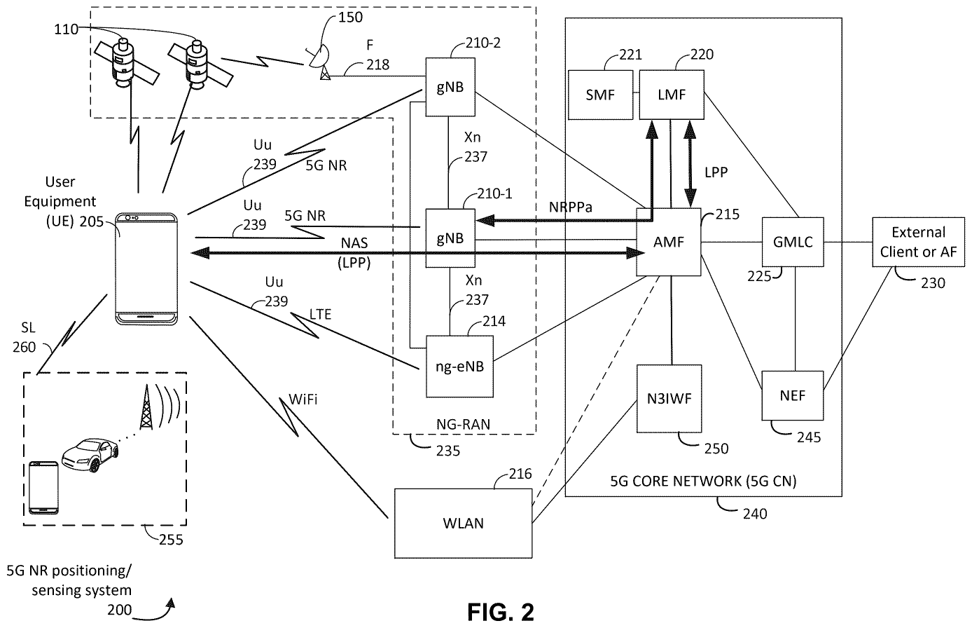

FIG. 1 is a simplified illustration of a positioning/sensing system 100 in which a UE 105, location/sensing server 160, and/or other components of the positioning system 100 can use the techniques provided herein for calibrating distance estimation with a target wireless device using a measuring wireless device (e.g., UE 105), according to an embodiment. The techniques described herein may be implemented by one or more components of the positioning/sensing system 100. However, the techniques described herein are not limited to such components and may be implemented in other types of systems (not shown). The positioning/sensing system 100 can include: a UE 105; one or more satellites 110 (also referred to as space vehicles (SVs)) for a Global Navigation Satellite System (GNSS) (e.g., the Global Positioning System (GPS), GLONASS, Galileo, or Beidou) and/or Non-Terrestrial Network (NTN) functionality; base stations 120; access points (APs) 130; location/sensing server 160; network 170; and external client 180. UE 105 may also refer to a mobile device (or vice versa) in some contexts of the present disclosure. Generally put, the positioning/sensing system 100 can estimate a location of the UE 105 based on RF signals received by and/or sent from the UE 105 and known locations of other components (e.g., GNSS satellites 110, base stations 120, APs 130) transmitting and/or receiving the RF signals. Additionally or alternatively, wireless devices such as the UE 105, base stations 120, and satellites 110 (and/or other NTN platforms, which may be implemented on balloons, etc.) can be utilized to perform positioning (e.g., of one or more wireless devices) and/or perform RF sensing (e.g., of one or more objects by using RF signals transmitted by one or more wireless devices). Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location/sensing server 160, by accessing the network 170 via a base station 120 using a first communication link 133. Additionally or alternatively, because APs 130 also may be communicatively coupled with the network 170, UE 105 may communicate with network-connected and Internet-connected devices, including location/sensing server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, where the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

Satellites 110 may be utilized in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server, which may operate as a location/sensing server 160. In some embodiments, satellites 110 used for NTN-based positioning may be different than those used for GNSS-based positioning. In some embodiments NTN nodes may include non-terrestrial vehicles such as balloons, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of UE 105 and/or provide data (e.g., “assistance data”) to UE 105 to facilitate location measurement and/or location determination by UE 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location/sensing server 160. In some embodiments, the location/sensing server 160 may comprise a Discovered SLP (D-SLP) or an Emergency SLP (E-SLP). The location/sensing server 160 may also comprise an Enhanced Serving Mobile Location Center (E-SMLC) that supports location of UE 105 using a control plane (CP) location solution for LTE radio access by UE 105. The location/sensing server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location/sensing server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning/sensing system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the UE 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, radio frequency identification (RFID), or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning/sensing system 100 can be implemented using a wireless communication network, such as an LTE-based or 5G NR-based network, or a future network (e.g., 6G network). FIG. 2 shows a diagram of a 5G NR positioning/sensing system 200, illustrating an embodiment of a positioning/sensing system (e.g., positioning/sensing system 100) implementing 5G NR. The 5G NR positioning/sensing system 200 may be configured to enable wireless communication, determine the location of a UE 205 (which may be an example of UE 105 of FIG. 1), performing RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods and/or one or more sensing methods. These access nodes can use RF signaling to enable the communication, implement the one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may be configured to coordinate RF sensing by the 5G NR positioning/sensing system 200. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning System (GPS) or similar system (e.g., GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNB 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMFs) 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning system/sensing 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216, or NTN satellite 110, or a combination thereof (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted or UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220, described in more detail hereafter.

Positioning of the UE 205 in a 5G NR positioning/sensing system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

The principles described above with respect to positioning may be generally extended to RF sensing. That is, RF sensing may be UE based (e.g., originated from the UE) and/or UE assisted (e.g., originated from a non-UE entity), and may involve UL signals, DL signals, or both. However, RF sensing may differ from positioning in various ways. For example, as previously noted and described in more detail below, RF sensing may involve the use of specific RF sensing signals. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof).

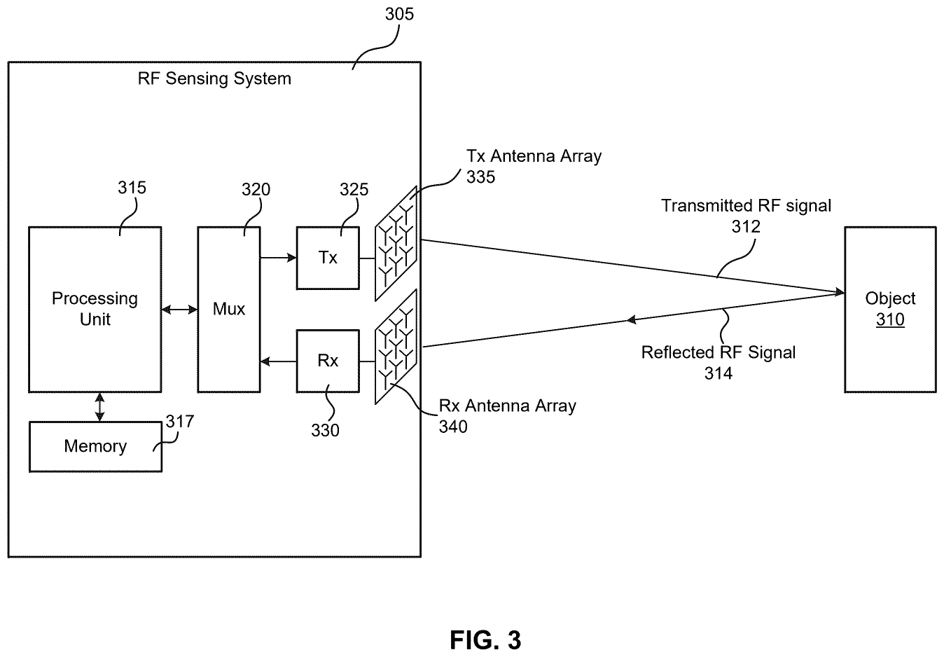

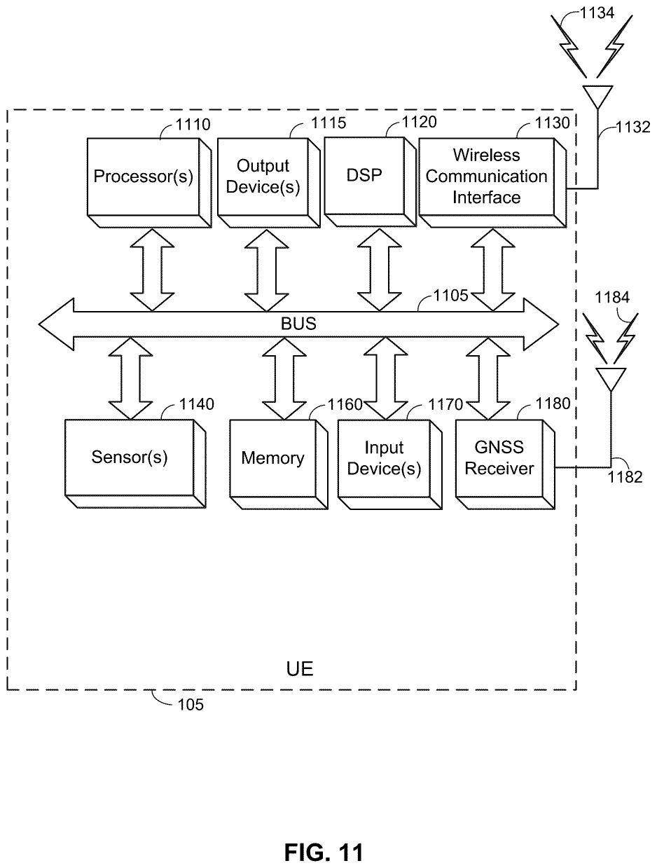

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device (e.g., the UE disclosed herein), such as a mobile phone, UE, a base station/access node, a satellite, or other type of sensing node as described herein. (Example components of such electronic devices are illustrated in FIGS. 11-13, discussed in detail hereafter.)

Sensing algorithms may utilize monostatic sensing or bistatic or multistatic sensing. Monostatic sensing involves using a pair of co-located transmitter and receiver to sense the environment, while bistatic or multistatic sensing involves using separated transmitters and receivers to sense environment.

It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 may reflect off of the object 310, and these reflected RF signals 314 (or “echoes”) may then be processed by the RF sensing system 305 using beamforming (BF) and digital signal processing (DSP) techniques to determine the location of the object 310 (azimuth, elevation, velocity (e.g., from Doppler measurements), and/or range) relative to the RF sensing system 305. Constant false alarm rate (CFAR) detection may be part of this processing, but may not necessarily be used in every instance, or “occasion,” in which RF sensing is performed.

To enable RF sensing, RF sensing system 305 may in some implementations include a processing unit 315, a memory 317, a multiplexer (mux) 320, Tx processing circuitry 325, and Rx processing circuitry 330. Some implementations of the RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit 315 may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 may include a plurality of antenna elements. It can be noted that, although the antenna arrays 335, 340 of FIG. 3 can include two-dimensional arrays, embodiments are not so limited. Arrays may simply include a plurality of antenna elements along a single dimension that provides for spatial cancelation between the Tx and Rx sides of the RF sensing system 305. As a person of ordinary skill in the art will appreciate, the relative location of the Tx and Rx sides, in addition to various environmental factors can impact how spatial cancelation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in a mobile device or UE (e.g., 105, 205), including modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian intrusion detection in highways and railways, rainfall monitoring, flooding awareness, autonomous driving, automated guided vehicle (AGV) detection/tracking/collision avoidance, smart parking and assistance, vehicle trajectory and tracking, crowd management, sleep/health monitoring, gesture recognition, XR streaming, public safety, search and rescue, and more. Further, RF sensing is expected to be incorporated into wireless standards (e.g., 5G, 6G), and therefore may be performed in the future in a cellular network.

### RTT Calibration

RTT timestamps may reflect the time when a signal is first received at the hardware of a device, e.g., antenna port of a target device. RTT timestamps may be captured at the physical layer (PHY) of the device. RTT calibration may involve calibration of the time difference (delta) between when timestamps are captured at the PHY and when the signal is received at the antenna port. The time delta may include digital delay (processing, computation, etc.), analog delay from components (e.g., filters), and/or circuitry delay from the path taken by electrical signals through the antenna, circuit board within the chip, etc. These delays may also vary depending on device configuration, device mode (e.g., low power), device capability, available power, and/or age of device, which may change over time and vary from device to device, thereby influencing devices and their delays in different ways.

Challenges of RTT calibration are due to the above delays, complexity of multi-stage RTT calibration, number of test modes needing calibration, and difficulty for manufacturers and end users in completing full RTT calibration for every device. As noted above, minute changes in RTT may affect distance estimations greatly. As there are many uncalibrated devices (e.g., in the billions) on the market, RTT calibration is a significant hurdle that limits the adoption of RTT technology for incumbent and future devices that may require RTT-based location features, for example, devices using standards such as IEEE 802.11mc, 802.11az, or 802.11bk (which use Wi-Fi RTT), or 802.15.4z or 802.15.4ab (which use UWB RTT).

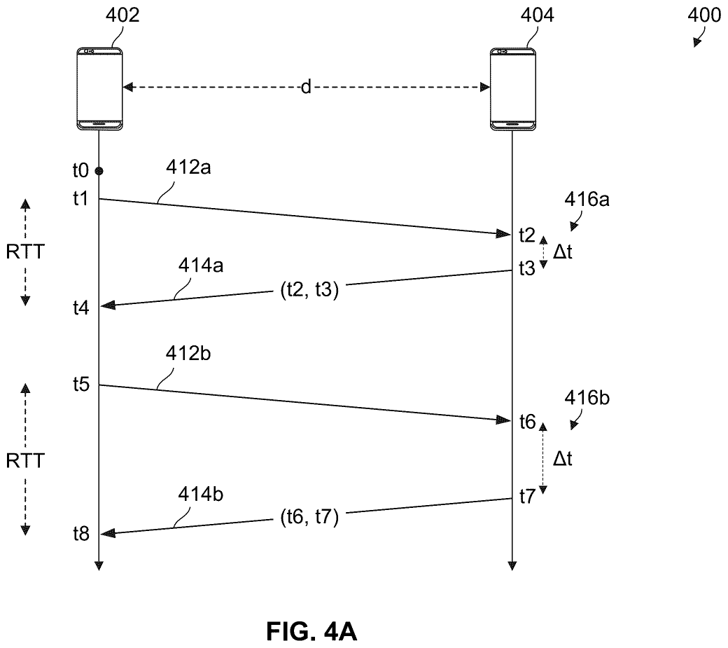

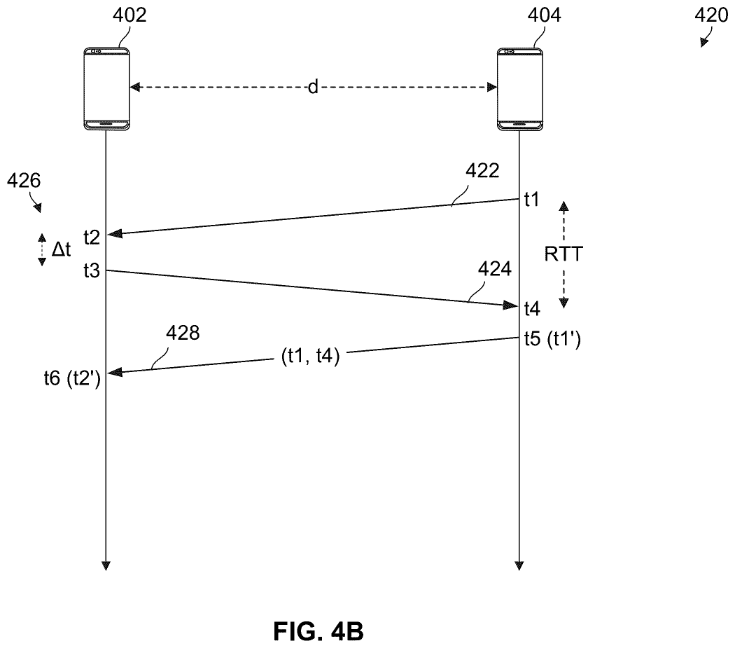

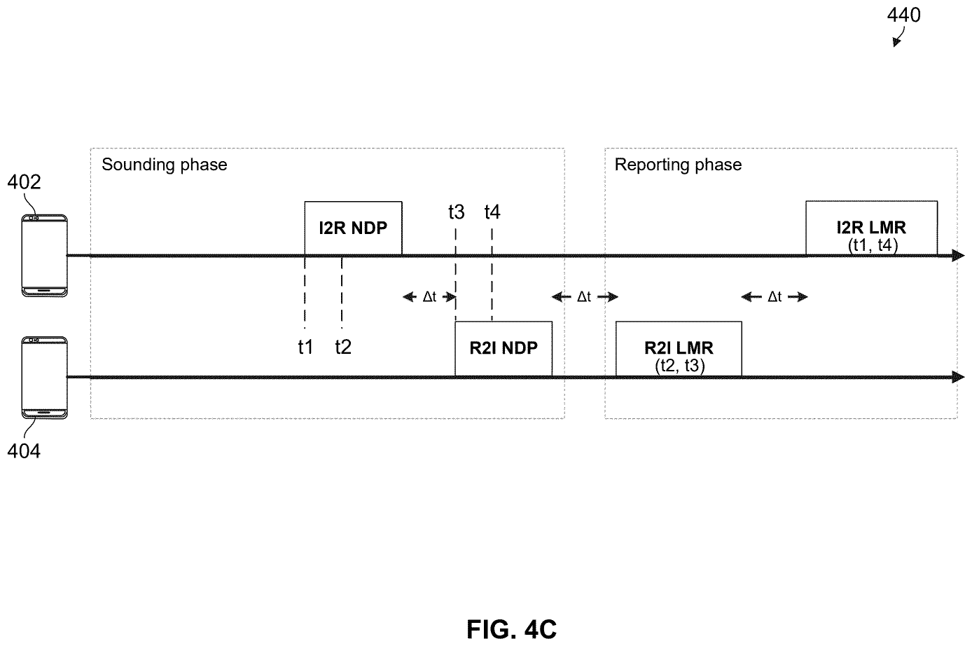

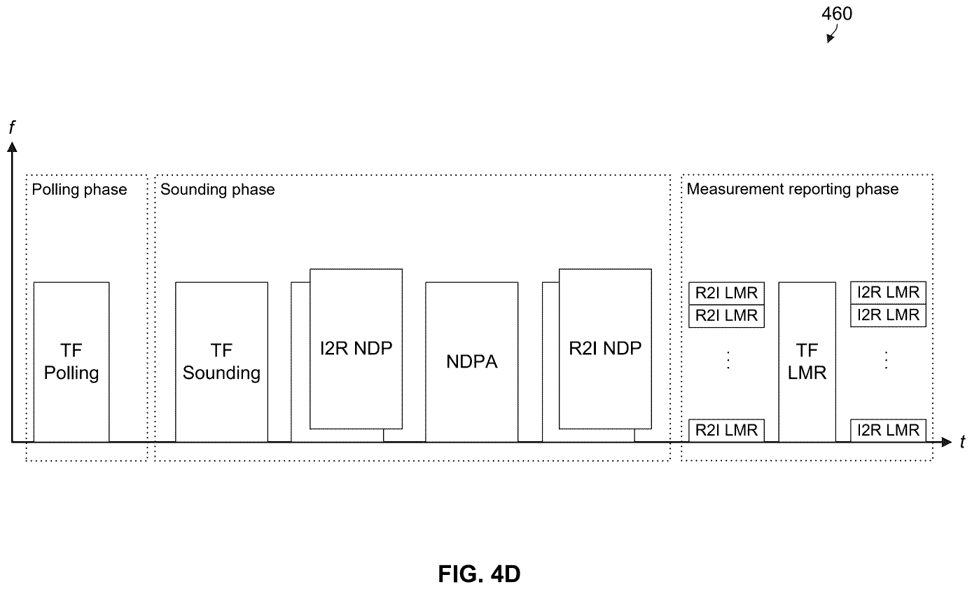

FIG. 4A is a ladder diagram 400 illustrating example Round Trip Time measurements between two wireless devices. Each device may be of the type discussed above, e.g., mobile devices or UEs. In some examples, both devices may be capable of RTT, wherein a measuring wireless device 402 may be configured to perform RTT measurements with a target wireless device 404, as shown. In some implementations, RTT measurements may be performed using Wi-Fi signals between the measuring wireless device 402 and the target wireless device 404. In some examples, the measuring wireless 402 may be the initiator, and the target wireless device 404 may be the responder. That is, the measuring wireless device 402 may be capable of sending a signal, and the target wireless device 404 may be capable of sending a signal back to the measuring wireless device 402 after receipt of the signal.

According to the example shown in ladder diagram 400, at time t1, the measuring wireless device 402 may send a first signal 412a toward the target wireless device 404, which may occur, e.g., in response to a request from the target wireless device 404. The target wireless device 404 may receive the first signal 412a at time t2, and subsequently send a second signal 414a back to the target wireless device 404 at time t3. There may be a time delta 416a between times t2 and t3 as a result of processing delays from digital, analog, and/or circuitry delays as mentioned above. The measuring wireless device 402 may receive the second signal 414a at time t4. Times t1 through t4 may be timestamped by the devices; e.g., t2 and t3 may be recorded by the target wireless device 404 and received with (e.g., embedded in) the second signal 414a. The resulting time difference represented by (t4−t1)−(t3−t2) may be referred to as the RTT, measured by the measuring wireless device 402. Essentially, the time difference between timestamped times t1 and t4 without the time delta 416a between times t2 and t3 leaves the round-trip time taken for the first signal 412a to travel and for the second signal 414a to return.

In some examples, such as (but not limited to) when using 802.11mc-based RTT or Wi-Fi RTT, the measuring wireless 402 may perform RTT by sending back a signal received from the target wireless device 404, where the target wireless device 404 may be the initiator and the measuring wireless 402 may be the responder.

Referring briefly to FIG. 4B, ladder diagram 420 illustrates another example Round Trip Time measurements between two wireless devices. As shown, the target wireless device 404 may send a first signal 422 at time t1 toward the measuring wireless device 402, which may occur, e.g., in response to a request from the measuring wireless device 402. The measuring wireless device 402 may receive the first signal 422 at time t2, and subsequently send a second signal 424 back to the target wireless device 404 at time t3. There may be a time delta 426 between times t2 and t3 as a result of processing delays from digital, analog, and/or circuitry delays as mentioned above. The target wireless device 404 may receive the second signal 424 at time t4. Further, the target wireless device 404 may send timestamp information for t1 and t4 in a third signal 428. The measuring wireless device 402 may thereby collect all four timestamps t1, t2, t3 and t4 and compute the RTT. In some cases, the third signal 428 including the timestamps t1 and t4 may correspond to another first signal sent by target wireless device 404 at time t5 (corresponding to time t1') and received by measuring wireless device 402 at time t6 (corresponding to time t2') for a subsequent RTT measurement, which may continue as described above.

In addition to 802.11mc, as noted above, Wi-Fi RTT is also supported in the 802.11az Next Generation Positioning specification and the 802.11bk 320 MHz Positioning specification. In 802.11az and 802.11bk, both non-trigger-based (NTB) sensing or ranging measurements and trigger-based (TB) sensing or ranging measurement sequences may be used. In TB measurements, another entity other than the participating measuring device and the target device, such as an access point or base station, can initiate the measurements by polling the wireless devices, which may allow the access point to check the availability of the wireless devices. In NTB measurements, the participating measuring device (or target device) may initiate the measurements.

As an example of NTB measurements illustrated in ladder diagram 440 in FIG. 4C, in some implementations, an initiator (e.g., measuring wireless device 402) may send an initiator-to-responder (I2R) null-data packet (I2R NDP) toward a responder (e.g., target wireless device 404) and capture t1 at the start of transmitting the I2R NDP, the target device may receive the I2R NDP and capture t2 at the time of arrival of the I2R NDP, the target device may send a responder-to-initiator (R2I) NDP (R2I NDP) and capture t3 at the start of transmitting the R2I NDP, and the measuring device may receive the R2I NDP and capture t4 at the time of arrival of the R2I NDP. A short interframe space (SIFS) may be present between the sending of the I2R NDP and the sending of the R2I NDP, where the SIFS may correspond to a time delta and account for part of the RTT. The target device may then provide t2 and t3 to the measuring device via an R2I location measurement report (R2I LMR). In some variants, the measuring device may also provide t1 and t4 to the target device via an I2R LMR. These sequences are similar to the RTT sequence during t1 through t4 shown in FIG. 4A, except that timestamps may be reported to the other device using separate LMR frames, rather than reusing some of the measurement frames (e.g., received with second signal 414a).

An example of TB measurements is illustrated in sequence diagram 460 in FIG. 4D. In some configurations, the measuring wireless device can be configured to operate as a “soft access point.” In this mode, the measuring wireless device may operate as the responder participating in TB ranging while the target wireless device may operate as the initiator. The measuring wireless device may transmit a trigger frame (TF) poll to one or more target wireless devices during a polling phase, followed by a TF sound to solicit an I2R NDP. The target wireless device(s) may send the I2R NDP and capture timestamp t1. The measuring wireless device may receive the I2R NDP and capture timestamp t2 at the time of receipt. The sequence may continue with the measuring wireless device transmitting a null data packet announcement (NDPA) and R2I NDP to the target wireless device(s), capturing timestamp t3 at the time of departure of the R2I NDP, while the target wireless device(s) may capture timestamp t4 at the time of arrival of the R2I NDP. During a measurement reporting phase, the measuring wireless device may share its captured timestamps t2 and t3 in R2I LMR, and the target wireless device(s) may share their captured timestamps t1 and t4 in I2R LMR.

In some configurations, the target wireless device can be configured to operate as the soft access point. In such configurations, the target wireless device may transmit these TF frames (e.g., for polling, sounding, LMR) to the measuring wireless device.

In some scenarios, the measuring wireless device 402 and the target wireless device 404 may be a distance d apart, which may be the length over which a signal travels from one device to the other device, assuming the devices stay stationary (e.g., during calibration). Distance d may be estimated based on the RTT, according to d=RTT*c/2, where c represents the speed of light. The RTT may include two components: true RTT (t_{RTT}) and error in RTT measurement (e_{RTT}), which will be considered during calibration in some embodiments, as will be discussed further below. Saliently, d may also be estimated based on one of various approaches as will be discussed further below.

In some implementations, further RTT measurements between the measuring wireless device 402 and the target wireless device 404 may be performed using a third signal 412b sent at time t5 and received at time t6, and a fourth signal 414b subsequently sent at time t7 and received at time t8. The third signal 412b may be an example of the first signal 412a, and the fourth signal 414b may be an example of the second signal 414a.

However, in this scenario, there may be a time delta 416b between times t6 and t7 that is longer compared to the time delta 416a between times t2 and t3. In other scenarios, a time delta may be shorter than time delta 416a, or substantially similar within a range, or equal. The longer time delta 416b may be caused by various factors other than processing delays. For example, multipath, environment (e.g., a dynamic environment may have moving objects that may affect signal transmission), transmission medium, temperature, gain in receiver, traffic level, channel configuration, signal quality, signal noise, and/or signal corruption may affect the arrival time of signals, response time, and even the sending time. For example, in some scenarios, time t1 may be recorded as time t1 even though the true sending time was at time t0.

Hence, in some implementations, RTT measurements may be performed multiple times. In some approaches, the multiple RTT measurements may be averaged to obtain a composite RTT (e.g., mean, root mean square, time-weighted average with increased weight for more recent measurements). In some approaches, corrupt signals and/or signals having an error exceeding a threshold may be discarded. In some approaches, multiple distances estimated based on the multiple RTT measurements may be averaged and/or at least partly discarded (e.g., if distance or error exceeds a threshold or is an outlier that exceeds the average by a threshold) to obtain a composite distance estimate.

While the above example does not require a router or other hops, in some specific scenarios (e.g., RTT with a router or other access point), the signals may be transmitted through one or more network nodes, including one or more of a router, server, access point, etc., which may introduce additional delays from processing and response times at each node.

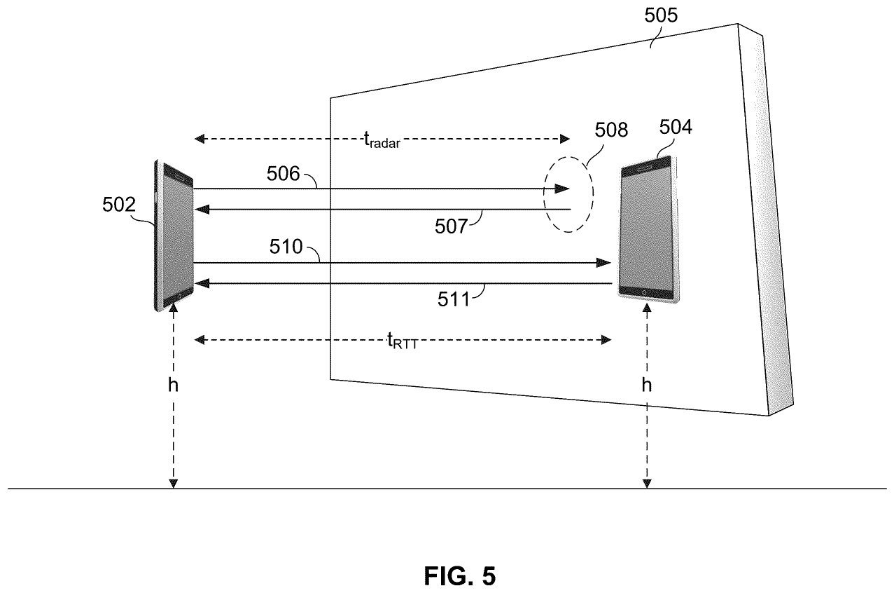

FIG. 5 shows a diagram of an example approach to Round Trip Time (RTT) calibration between two wireless devices, according to some embodiments. In this example approach, a target wireless device 504 may be fixed against a reference object that is immediately proximate or adjacent to the target wireless device 504 (e.g., no farther than a set distance). As an example, the target wireless device 504 may be placed against a flat surface, such as a wall 505. Various means for securing the target wireless device 504 may be employed, such as a shelf, adhesives, mounts, manual holding by a user, etc.

In some cases, the measuring wireless device 502 may be secured at some distance away from the target wireless device 504. In some cases, the measuring wireless device 502 may be held by a user. The measuring wireless device 502 and the target wireless device 504 may be disposed such that they are both at the same vertical height (h) or approximately the same height (e.g., within a certain deviation), e.g., from the floor. In some cases, the measuring wireless device 502 may provide guidance for the height. For example, an app may instruct the user to point the measuring wireless device 502 toward a reflective object, such as the wall 505. In some configurations (e.g., in an app), provide an alert to place the measuring wireless device 502 closer toward the compliant height. The target wireless device 504 may also guide a user to place the target wireless device 504 at a certain location (e.g., at height h), or accept the location (including height) when placed by a user, which may then be communicated to the measuring wireless device 502 so that the measuring wireless device 502 may provide guidance based thereon. In some configurations, the measuring wireless device 502 and the target wireless device 504 may have communicated with a request and acknowledgment that calibration is to take place.

In some approaches, a target wireless device may be determined to be at a fixed position relative to a measuring wireless device based on a user request at the measuring wireless device, inertial data of the measuring wireless device, sensed indication of the target wireless device, or a combination thereof.

In some implementations, a user request may be a user calibration request or a command that initiates a calibration process when the user wishes to. For example, an input or command may be provided via a user interface associated with the measuring device to receive such an input or command.

In some implementations, the inertial data of the measuring wireless device may be obtained from an inertial sensor (e.g., sensor(s) 1140 such as an accelerometer or a gyroscope) of the measuring wireless device, which may also be referred to herein as an inertial measurement unit (IMU) and configured to measure a motion of the associated device. In scenarios where there is minimal to no motion of the measuring wireless device detected by the IMU, the inertial data may have magnitudes below a threshold or within a range to indicate the immobility of the measuring wireless device. In some implementations, IMU data for the target wireless device may be obtained, e.g., received by the measuring wireless device, and may indicate an immobility of the target wireless device, and further enable determination that the two devices are at a fixed position relative to each other. In some implementations, inertial data may stay under a threshold or within a range for a requisite period of time before and during the measurements for the measuring wireless device and/or the target wireless device to be considered immobile; and if not, measurement(s) outside the threshold or range may be invalidated.

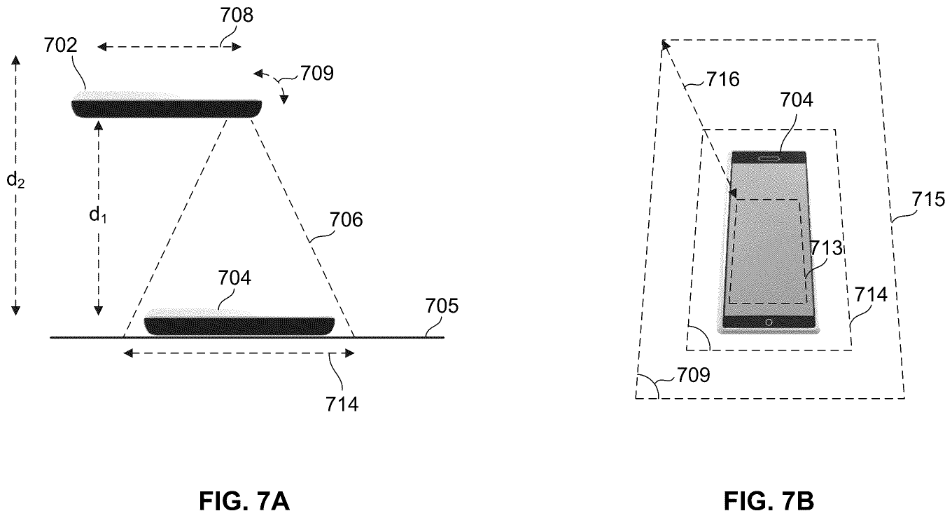

In some implementations, sensed indication of the target wireless device may include a visual indication, e.g., as detected visually using a camera within a visual zone, as will be discussed in greater detail with respect to FIG. 7. In some configurations, RF-based sensing (e.g., monostatic sensing) may be used to determine that the measuring wireless device is not moving with respect to another object such as the target wireless device, e.g., where the distance determined by RF sensing does not change within a range for a period of time.

Once the measuring wireless device 502 and the target wireless device 504 are disposed and oriented at the proper locations (e.g., at height h and facing each other while in an upright position), and/or determined to be at a fixed distance relative to each other, calibration may continue.

In some implementations, the measuring wireless device 502 may send a first RF signal 506 toward the reference object (e.g., wall 505). A reflected RF signal 507 may be received at the measuring wireless device 502. More specifically, in some scenarios, the first RF signal 506 may arrive at a region 508 of the wall 505, and the reflected RF signal 507 may be reflected from the region 508. A portion of the first RF signal 506 that hits the wall 505 may be reflected back to the measuring wireless device 502, depending on the reflection coefficient of the material of the wall 505 or other reference object.

The first RF signal 506 and the reflected RF signal 507 may correspond to the transmitted RF signal 312 and the reflected RF signal 314, respectively. That is, the measuring wireless device 502 may perform monostatic RF sensing with the reference object (e.g., wall 505) to estimate the time duration t_{RF} between sending the first RF signal 506 and receiving the reflected RF signal 507 using monostatic sensing. In various implementations, monostatic sensing may be performed using, e.g., Wi-Fi, mmWave, UWB, or RFID-based communication.

As noted above, the region 508 may be immediately adjacent to the target wireless device 504 so that t_{RF} may represent an accurate estimation of the time to reflect the first RF signal 506 from the target wireless device 504. However, in some approaches, the first RF signal 506 may be sent to the target wireless device 504, where the target wireless device 504 acts as a reference object (rather than a wireless-enabled device configured to send a signal back). The reflected RF signal 507 may then be a reflection of the first RF signal 506 sent to the target wireless device 504.

In either scenario, whether the reference object is the wall 505 or the target wireless device 504 itself (or another object), the reflection coefficient of the object (including, e.g., how much of a wave is reflected) may be used to determine whether such objects may be usable as the reference object. A reflection coefficient resulting in sufficient signal strength of the reflected RF signal 507 may avoid errors or inaccuracies.

In some implementations, the measuring wireless device 502 may send (or receive) a first wireless signal 510 to the target wireless device 504 to begin an RTT measurement. In some examples, the first wireless signal 510 may be a Wi-Fi signal containing one or more packets. A second wireless signal 511 may then be received at the measuring wireless device 502 from the target wireless device 504. The target wireless device 504 may be configured to send the second wireless signal 511 in response to receiving the first wireless signal 510. In some examples, the second wireless signal 511 may be a Wi-Fi signal containing one or more packets, including a timestamp at which the first wireless signal 510 was received and the second wireless signal 511 was sent by the target wireless device 504.

In some examples, the above exchange of first and second wireless signals 510 and 511 may correspond to the first signal 412a sent at time t1 from the measuring wireless device 402 and the second signal 414a received at time t4 at the measuring wireless device 402, respectively, where the first signal 412a may be received at the target wireless device 404 at time t2 and the second signal 414a may be sent at time t3 to the measuring wireless device 402.

Accordingly, in some implementations, the measuring wireless device 502 may perform an RTT measurement using the exchange of first and second wireless signals 510 and 511 to obtain t_{RTT}. In this case, t_{RTT} may be determined by taking the difference between the time difference between the receipt of the second wireless signal 511 (at time t4) and the transmission of the first wireless signal 510 (at time t1) at the measuring wireless device 502, and the time difference between the transmission of the second wireless signal 511 (at time t3) and the receipt of the first wireless signal 510 at the target wireless device 504 (at time t2). That is, t_{RTT}=(t4−t1)−(t3−t2).

However, t_{RTT} may include an error component, as discussed above. t_{RTT} can be represented as t_{RTT}=tₜᵣᵤₑ+e_{RTT}, where tₜᵣᵤₑ represents the actual round-trip time and e_{RTT} represents an error or bias in the RTT measurement. This error may be unknown prior to calibration.

Since monostatic sensing does not require calibration, it may be assumed that t_{RF}=tₜᵣᵤₑ. Thus, in some approaches, the measuring wireless device 502 may estimate e_{RTT} as e_{RTT}=t_{RTT}−t_{RF}. In other words, the error component in the RTT measurement may be determined using the RF-based measurement with the reference object.

The measuring wireless device 502 may calibrate the RTT measurement based on the estimated error e_{RTT}. In some implementations, the measuring wireless device 502 may associate the target wireless device 504 with the error e_{RTT}. For example, a profile or other data structure specific to the target wireless device 504 may indicate that e_{RTT} should be removed to obtain a more credible, calibrated, and accurate RTT measurement with the target wireless device 504. The error may be stored or otherwise accessible in various ways familiar to those having ordinary skill in the relevant arts.

Every device may have its own RTT error associated therewith, given the variations in device configurations, capabilities, mode, processing delays (e.g., digital, analog, and/or circuitry), etc. The measuring wireless device 502 may store respective errors or biases associated with another target device (not shown) in its own profile. Hence, when communicating with a particular device, the measuring wireless device 502 may calibrate RTT measurements using the profile for that particular device.

It will become apparent that, to perform the example approach shown in FIG. 5, measuring wireless device 502 may be a device capable of monostatic RF sensing and RTT, and target wireless device 504 may be a device capable of at least RTT. In some implementations, the measuring wireless device 502 may perform RTT measurement(s) after the monostatic RF sensing. In some cases, the RTT measurement(s) may be performed immediately after (e.g., within a time range) the RF sensing, concurrently to the RF sensing, or immediately prior (e.g., within a time range) to the RF sensing. The closer the measurement of t_{RF} and t_{RTT}, the more meaningful the comparison.

Each of the above steps may be performed by an end user to perform RTT calibration. Advantageously, obtaining t_{RF} using monostatic sensing does not require calibration, and thus, the obtained t_{RF} may be used to estimate any errors or bias when performing RTT to determine t_{RTT}.

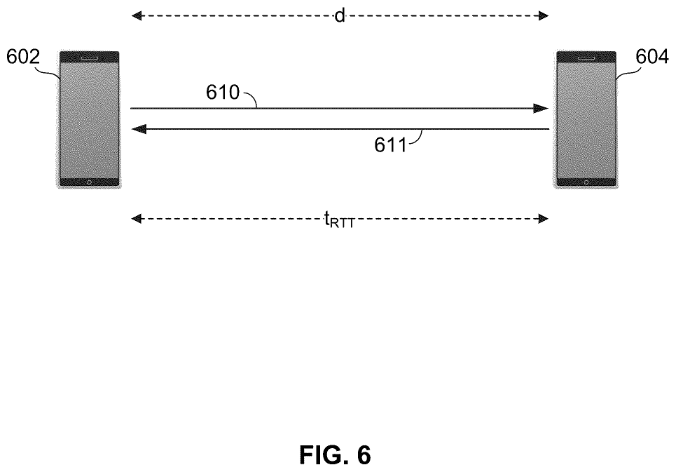

FIG. 6 shows a diagram of another example approach to RTT calibration between two wireless devices, according to some embodiments. In this example approach, a measuring wireless device 602 and a target wireless device 604 may be disposed at a known distance d apart from each other. For example, the user may be provided guidance (e.g., by the measuring wireless device 602) to hold the measuring wireless device 602 and the target wireless device 604 about 1 meter apart. In another example, the user may be instructed to place the measuring wireless device 602 and the target wireless device 604 next to each other on a flat surface (e.g., a table) or on top of each other, which would make the true distance between the devices close to or approximately zero but nonetheless may be known to the measuring wireless device 602, e.g., based on device specifications communicated to it.

In some implementations, the measuring wireless device 602 may perform RTT measurement(s) according to above, e.g., by sending (or receiving) a first wireless signal 610 to the target wireless device 604 and then receiving a second wireless signal 611 from the target wireless device 604. The first wireless signal 610 and the second wireless signal 611 may be Wi-Fi signals each containing one or more packets, in some examples. In some implementations, the second wireless signal 611 may indicate timestamps at which the first wireless signal 610 was received and the second wireless signal 611 was sent by the target wireless device 604. In some examples, first and second wireless signals 610 and 611 may correspond to the first signal 412a sent at time t1 from the measuring wireless device 402 and the second signal 414a received at time t4 at the measuring wireless device 402, respectively, where the first signal 412a may be received at the target wireless device 404 at time t2 and the second signal 414a may be sent at time t3 to the measuring wireless device 402.

Accordingly, in some implementations, the measuring wireless device 602 may perform an RTT measurement using the exchange of first and second wireless signals 610 and 611 to obtain t_{RTT}, which may be determined by taking the difference between the time difference between the time of receipt of the second wireless signal 611 and the time of transmission of the first wireless signal 610 at the measuring wireless device 602, and the time difference between the time of transmission of the second wireless signal 611 and the time of receipt of the first wireless signal 610 at the target wireless device 604, similar to the RTT measurement discussed above.

In some implementations, multiple RTT measurements may be performed to obtain t_{RTT}, e.g., via averaging and/or discarding.

In some approaches, the measuring wireless device 602 may estimate the error component e_{RTT} of the t_{RTT} based on a round-trip time calculated based on the known distance d. For example, the relationship d=(tₜᵣᵤₑ)*c/2 may be used to determine the tₜᵣᵤₑ component by rearranging to 2d/c=tₜᵣᵤₑ. e_{RTT} may then be estimated as t_{RTT}−tₜᵣᵤₑ.

The measuring wireless device 602 may calibrate the RTT measurement based on this estimated error e_{RTT}, e.g., by associating the e_{RTT} with the target wireless device 604 (e.g., storing in a profile associated with the target wireless device 604) and removing the e_{RTT} with RTT measurements with the target wireless device 604. Other devices (not shown) may also be calibrated in similar way by obtaining a known distance with each particular device and estimating the error based on the RTT measurements (which may vary) with each particular device.

Advantageously, the example approach of FIG. 6 does not require monostatic sensing or any other complex techniques to assist with RTT calibration. The example approach of FIG. 6 may also be sufficient to calibrate the majority of the RTT bias, leading to more accurate RTT measurements.

However, in some approaches, the measuring wireless device 602 may additionally perform monostatic sensing as discussed with respect to FIG. 5. That is to say, t_{RF} may be obtained using RF signals exchanged between the measuring wireless device 602 and the target wireless device 604 while they are disposed adjacent to each other, while knowing or not knowing the distance d.

In some approaches, where d is known, monostatic sensing may provide further corroboration for tₜᵣᵤₑ. For instance, tₜᵣᵤₑ estimated using known distance d may be averaged with tₜᵣᵤₑ estimated using monostatic sensing. In some cases, corroboration may include keeping tₜᵣᵤₑ estimated using known distance d if within a range of the tₜᵣᵤₑ estimated using monostatic sensing (or vice versa), and discarding tₜᵣᵤₑ estimated using known distance d otherwise. In some cases, multiple tₜᵣᵤₑ estimations may be determined using known distance d and averaged. In some cases, multiple tₜᵣᵤₑ estimations may be determined using monostatic sensing and averaged. In some cases, the sets of multiple tₜᵣᵤₑ estimations from both approaches may be averaged. By combining these approaches, a more credible and accurate estimation of tₜᵣᵤₑ may be obtained, thereby improving the accuracy of e_{RTT} for calibration. In some cases, multiple error estimations can be averaged, such as the error estimated from a known distance (d) and the error estimated from monostatic sensing.

FIGS. 7A and 7B show views of another example approach to RTT calibration between two wireless devices, according to some embodiments. FIG. 7A shows a side view of a measuring wireless device 702 and a target wireless device 704 placed relative to each other. For example, the target wireless device 704 may be placed on a flat surface 705 (e.g., table, wall), while the measuring wireless device 702 may be held (e.g., by a user) or fixed at some initial distance. In some embodiments, measuring wireless device 702 may include a camera or other visual or optical sensor to obtain image data of the environment in real time (e.g., as the measuring wireless device 702 moves relative to the target wireless device 704).

As shown in FIG. 7A, the measuring wireless device 702 may be positioned such that the target wireless device 704 is within a field of view 706 of the camera of the measuring wireless device 702. This may involve orienting the measuring wireless device 702 (e.g., horizontally along an extent 708, vertically (e.g., between d₁ and d₂), and/or along an angle 709) so that the target wireless device 704 is within the field of view 706 until detected.

As shown in FIG. 7B, which shows a top-down view of the target wireless device 704 at a slight angle 709 relative to a horizontal plane (e.g., along extent 708), the target wireless device 704 may be considered to be detected if it is sufficiently within a detection zone, such as if the field of view 706 shows a zone 714. In some examples, the measuring wireless device 702 may be moved closer and away from the target wireless device 704 to change the field of view 706 along a path 716. If the field of view 706 shows a larger zone 715, the measuring wireless device 702 may be too far away from the target wireless device 704, and the target wireless device 704 may not be detected. Similarly, if the field of view 706 shows a smaller zone 713, the measuring wireless device 702 may be too closer to the target wireless device 704, and the target wireless device 704 may not be detected. When the target wireless device 704 is detected, the detection may be indicated to the user (e.g., user interface showing the field of view 706 may change color, border size, etc.).

In some embodiments, when or while the target wireless device 704 is detected (e.g., the field of view 706 of the camera shows target wireless device 704 within zone 714), the measuring wireless device 702 may capture image data (e.g., automatedly or based on user command, e.g., toggling a shutter). Such image data may include the target wireless device 704.

In some embodiments, image data may be captured over a period of time, e.g., the holding time. During this holding time, the measuring wireless device 702 may perform RTT measurements, e.g., as described above.

Further, the measuring wireless device 702 may estimate a distance to the target wireless device 704 (and/or other nearby objects) using image processing of image data obtained by the camera or other sensor. In some examples, the measuring wireless device 702 may be configured to assume a distance if the target wireless device 704 appears within a zone (e.g., the zone 714). In some implementations, depth tracking may be used to determine the distance from the measuring wireless device 702 to the target wireless device 704. In some cases, pixel analysis may be performed by comparing certain features of the target wireless device 704. For example, a location of pixels associated with one side of the target wireless device 704 could be compared to a location of pixels associated with another side of the target wireless device 704 to estimate a distance to the target wireless device 704 which corresponds to the distance between the pixel locations.

In some examples, the measuring wireless device 702 may obtain images and/or videos (e.g., multiple image frames) using the camera or other visual or optical sensor. Image analysis logic may be implemented by the measuring wireless device 702 to perform an image processing routine such as segmentation or other edge finding routine. For instance, an edge detection method such as segmentation may be used to find edges or boundaries of objects in the environment within an image or video. For instance, keypoints may be identified and matched between multiple images, e.g., using image processing algorithms such as scale-invariant feature transform (SIFT) feature detectors, and/or feature matching algorithms such as Fast Library for Approximate Nearest Neighbors (FLANN)-based methods to choose the best algorithm and optimum parameters (or using similar methods optimized for fast nearest neighbor search in large datasets) and find matches. Further processing of camera images may include (a) data reduction, (b) denoising (e.g., gaussian blur) and/or (c) edge detection thresholding (e.g., a Canny sequence of filter).

In some implementations, the analysis logic may also employ a threshold-based method or a machine learning (ML)-based or deep learning model to identify objects, boundaries, or edges in an image. Continuing with the illustrative example, the measuring wireless device 702 may further be configured to access or generate ground truth labels using image analysis or other computer vision techniques. The ground truth labels may result from at least some of the above techniques, and may include edge or feature information and/or absolute or relative locations of objects from other objects. In some cases, the ground truth labels may be received or sent by the measuring wireless device 702 from or to another device or a network node (e.g., access point, base station), which in some cases may also implement a ML model configured to perform image analysis using the image data. The measuring wireless device 702 may be configured to use the captured image data and the ground truth labels to train, retrain, or finetune a machine learning model.

The ML model in this example may be configured to use further image data obtained (e.g., using the camera of the measuring wireless device 702) and ground truth labels to perform further training. In some cases, further image data may be of another modality (e.g., infrared or RF images). Training using different imaging modalities can enhance performance of the ML model outputs determining the distance to the target wireless device 704.

In some configurations, the measuring wireless device 702 may automatically detect a target object such as the target wireless device 704, e.g., using the approaches described above. For example, if the target wireless device 704 is within the zone 714, it may automatically capture a photo(s). In some configurations, the measuring wireless device 702 may prompt the user to provide an input (e.g., a shutter command) to capture a photo of the scene containing the target object such as the target wireless device 704. For example, an application or program (e.g., a camera application) operating on the measuring wireless device 702 may provide such a prompt on a display. In this way, the user can ensure that the object is clearly visible and distinguishable from the background prior to capturing the target object. The application may in some cases reject images that do not contain a clearly visible and distinguishable object (e.g., as determined using image analysis of the types described above).

In some configurations, an application may utilize image processing techniques (e.g., of the types described above) to detect and visually indicate detected objects in the image such as the target wireless device 704 (e.g., by highlighting the object, placing a border around the object, etc.). In some instances, the user may be able to interact with the detected or indicated object (e.g., by clicking or tapping on the target object shown on the display) to prompt the application to perform an operation, e.g., allowing the application to proceed with distance estimation to the detected object. This approach may be useful when the measuring device and the target device are of different types (e.g., smartphone measuring distance to an earbud), or different brands that do not share similar dimensions, native communication functionalities, or applications used.

In some embodiments, the distance between the measuring wireless device 702 and the target wireless device 704 may be estimated, e.g., as d₁, using the image-based approaches above. In some implementations, the estimated distance may be an average of multiple distance estimations using image data captured by the measuring wireless device 702. The measuring wireless device 702 may then estimate the error component e_{RTT} of the t_{RTT} based on an estimated round-trip time calculated based on the estimated distance (e.g., d₁). For example, RTT=2(d₁)/c=tₜᵣᵤₑ. e_{RTT} may then be estimated as t_{RTT}−tₜᵣᵤₑ.

The measuring wireless device 702 may calibrate the RTT measurement based on this estimated error e_{RTT}, e.g., by associating the e_{RTT} with the target wireless device 704 (e.g., storing in a profile associated with the target wireless device 704) and removing the e_{RTT} with RTT measurements with the target wireless device 704. Other devices (not shown) may also be calibrated in similar way by obtaining a known distance with each particular device and estimating the error based on the RTT measurements (which may vary) with each particular device.

Advantageously, the example approach of FIG. 7 also does not require monostatic sensing or any other complex techniques to assist with RTT calibration.

In some approaches, the measuring wireless device 702 may additionally perform monostatic sensing as discussed with respect to FIG. 5. As discussed with respect to FIG. 6, which does not require monostatic sensing, monostatic sensing here may provide further corroboration for tₜᵣᵤₑ, including, e.g., by averaging tₜᵣᵤₑ estimated using estimated distance d₁ with tₜᵣᵤₑ estimated using monostatic sensing, or by keeping or discarding depending on how close the tₜᵣᵤₑ estimations are (e.g., within a range).

### Methods

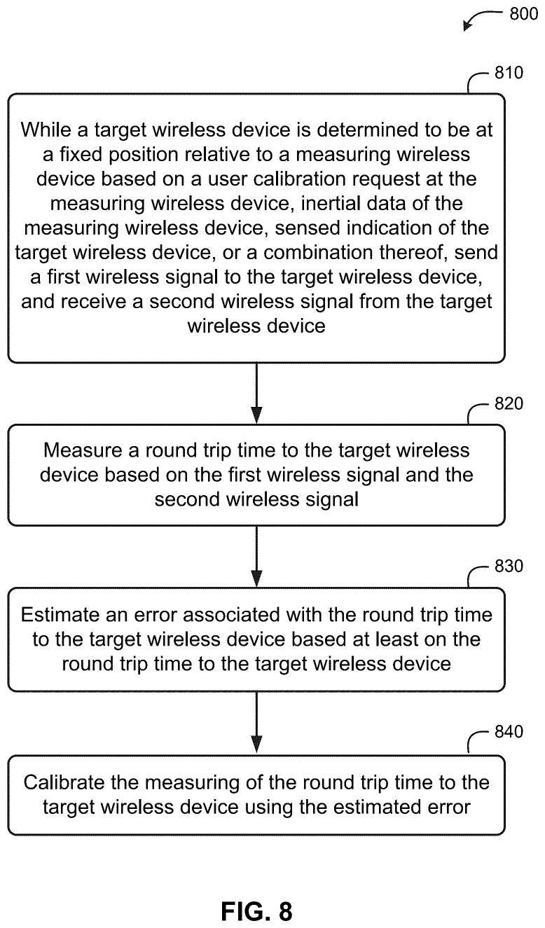

FIG. 8 is a flow diagram of a method 800 of calibrating distance estimation with a target wireless device using a measuring wireless device, according to some embodiments. Structure for performing the functionality illustrated in one or more of the blocks shown in FIG. 8 may include hardware and/or software components of a wireless device, such as, for example, a controller apparatus, a computerized system, or a computer-readable apparatus including a storage medium storing computer-readable and/or computer-executable instructions that are configured to, when executed by at least one processor apparatus, cause the at least one processor apparatus or the network node to perform the operations. Example components of a device (e.g., UE) are illustrated FIG. 11, which is described in more detail below.

It should also be noted that the operations of FIG. 8 may be performed in any suitable order, not necessarily the order depicted in FIG. 8. Further, the process shown in FIG. 8 may include additional or fewer operations than those depicted in FIG. 8.

At block 810, the method 800 may include, while the target wireless device is determined to be at a fixed position relative to the measuring wireless device, sending a first wireless signal to the target wireless device, and receiving a second wireless signal from the target wireless device. In some approaches, the target wireless device may be determined to be at the fixed position relative to the measuring wireless device based on a user calibration request at the measuring wireless device, inertial data of the measuring wireless device, sensed indication of the target wireless device, or a combination thereof.

In some embodiments, the position of the target wireless device relative to the measuring wireless device may include a position of the target wireless device which has a known distance to a position of the measuring wireless device. For example, see the approach described in relation to FIG. 6.

Means for performing functionality at block 810 may comprise a wireless communication interface 1130, wireless communication antenna(s) 1132, and/or other components of a device, such as a UE, as illustrated in FIG. 11.

At block 820, the method 800 may include measuring a round trip time to the target wireless device based on the first wireless signal and the second wireless signal.

Means for performing functionality at block 820 may comprise processor(s) 1110 and/or other components of a device, such as a UE, as illustrated in FIG. 11.

At block 830, the method 800 may include estimating an error associated with the round trip time to the target wireless device based at least on the round trip time to the target wireless device.

In some embodiments, the method 800 may further include: while the target wireless device is at the position, sending a first radio frequency (RF) signal to a reference object proximate the target wireless device, and receiving a second RF signal reflected from the reference object; and measuring a round trip time to the reference object based on the first RF signal and the second RF signal. In some implementations, the estimating of the error associated with the round trip time to the target wireless device may be further based on a difference between the round trip time to the target wireless device and the round trip time to the reference object. For example, see the approach described in relation to FIG. 5.

In some implementations, the position of the target wireless device relative to the measuring wireless device may include a position of the target wireless device having a vertical distance substantially equal to a vertical distance of a position of the measuring wireless device.

In some implementations, the first wireless signal may include a Wi-Fi signal sent to the target wireless device; and the second wireless signal may include a Wi-Fi signal received from the target wireless device in response to the Wi-Fi signal sent to the target wireless device.

In some scenarios, the reference object may include a surface against which the target wireless device is disposed (e.g., a wall); the first RF signal may be sent and the second RF signal may be received while the target wireless device is stationary against the surface; and the first RF signal may be sent from measuring wireless device and the second RF signal may be received at the measuring wireless device via an RF sensor or RF transceiver to perform monostatic RF sensing with a portion of the surface, the surface being proximate the target wireless device.

In some embodiments, the method 800 may further include: while the measuring wireless device is at the position relative to the target wireless device, obtaining image data associated with the target wireless device using a camera of the measuring wireless device; and estimating a distance between the measuring wireless device and the target wireless device based on the image data. In some applications, the position of the target wireless device relative to the measuring wireless device may be based on a user-guided placement of the measuring wireless device within a field of view of the camera of the measuring wireless device. For example, see the approach described in relation to FIG. 7.

In some embodiments, the estimating of the error associated with the round trip time to the target wireless device may be further based on the known distance to the position of the measuring wireless device (e.g., per the FIG. 6 approach).

In some embodiments, the error may be associated with the target wireless device, e.g., stored in a profile at or accessible to the measuring wireless device.

In some embodiments, the measuring wireless device may include one or more transceivers. The one or more transceivers may include a first transceiver and a second transceiver; the first transceiver may include a radio frequency (RF) transceiver configured to send the first RF signal to the reference object and receive the second RF signal; and the second transceiver may include a Wi-Fi transceiver configured to send the first wireless signal to the target wireless device and receive the second wireless signal.

Means for performing functionality at block 830 may comprise processor(s) 1110 and/or other components of a device, such as a UE, as illustrated in FIG. 11.

At block 840, the method 800 may include calibrating the measuring of the round trip time to the target wireless device using the estimated error. In some embodiments, the calibrating may include removing the estimated error from a round trip time measurement to the target wireless device based on the first wireless signal and the second wireless signal.

Means for performing functionality at block 840 may comprise processor(s) 1110 and/or other components of a device, such as a UE, as illustrated in FIG. 11.

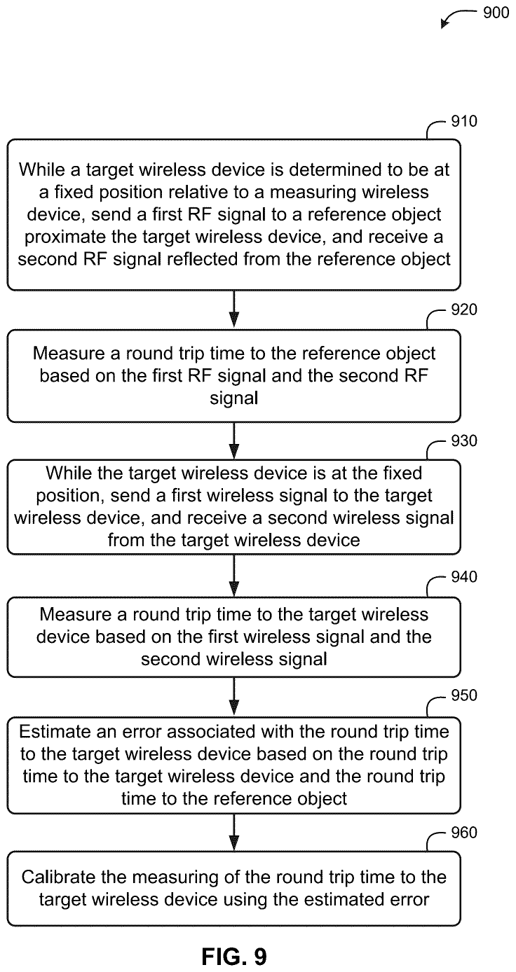

FIG. 9 is a flow diagram of a method 900 of calibrating distance estimation with a target wireless device using a measuring wireless device, according to some embodiments. Structure for performing the functionality illustrated in one or more of the blocks shown in FIG. 9 may include hardware and/or software components of a wireless device, such as, for example, a controller apparatus, a computerized system, or a computer-readable apparatus including a storage medium storing computer-readable and/or computer-executable instructions that are configured to, when executed by at least one processor apparatus, cause the at least one processor apparatus or the network node to perform the operations. Example components of a device (e.g., UE) are illustrated FIG. 11, which is described in more detail below.

It should also be noted that the operations of FIG. 9 may be performed in any suitable order, not necessarily the order depicted in FIG. 9. Further, the process shown in FIG. 9 may include additional or fewer operations than those depicted in FIG. 9.

At block 910, the method 900 may include, while the target wireless device is determined to be at a fixed position relative to the measuring wireless device, sending a first radio frequency (RF) signal to a reference object proximate the target wireless device, and receiving a second RF signal reflected from the reference object. In some approaches, the target wireless device may be determined to be at the fixed position relative to the measuring wireless device based on a user calibration request at the measuring wireless device, inertial data of the measuring wireless device, sensed indication of the target wireless device, or a combination thereof.

In some embodiments, the fixed position of the target wireless device relative to the measuring wireless device may include a position of the target wireless device having a vertical distance substantially equal to a vertical distance of a position of the measuring wireless device.

In some embodiments, the reference object comprises a surface against which the target wireless device is disposed; the first RF signal is sent and the second RF signal is received while the target wireless device is stationary against the surface; and the first RF signal is sent from measuring wireless device and the second RF signal is received at the measuring wireless device to perform monostatic RF sensing with a portion of the surface, the surface being proximate the target wireless device.

Means for performing functionality at block 910 may comprise a wireless communication interface 1130, wireless communication antenna(s) 1132, and/or other components of a device, such as a UE, as illustrated in FIG. 11.

At block 920, the method 900 may include measuring a round trip time to the reference object based on the first RF signal and the second RF signal.

Means for performing functionality at block 920 may comprise processor(s) 1110 and/or other components of a device, such as a UE, as illustrated in FIG. 11.

At block 930, the method 900 may include while the target wireless device is at the fixed position, sending a first wireless signal to the target wireless device, and receiving a second wireless signal from the target wireless device.

In some embodiments, the first wireless signal may include a Wi-Fi signal sent to the target wireless device; and the second wireless signal may include a Wi-Fi signal received from the target wireless device in response to the Wi-Fi signal sent to the target wireless device.

Means for performing functionality at block 930 may comprise a wireless communication interface 1130, wireless communication antenna(s) 1132, and/or other components of a device, such as a UE, as illustrated in FIG. 11.

At block 940, the method 900 may include measuring a round trip time to the target wireless device based on the first wireless signal and the second wireless signal.

Means for performing functionality at block 910 may comprise processor(s) 1110 and/or other components of a device, such as a UE, as illustrated in FIG. 11.

At block 950, the method 900 may include estimating an error associated with the round trip time to the target wireless device based on the round trip time to the target wireless device and the round trip time to the reference object.

In some embodiments, the estimating of the error associated with the round trip time to the target wireless device may include determining a difference between the round trip time to the target wireless device and the round trip time to the reference object.

In some embodiments, the estimating of the error may include subtracting the round trip time to the reference object based on the first RF signal and the second RF signal from the round trip time to the target wireless device based on the first wireless signal and the second wireless signal. For example, e_{RTT}=t_{RTT}−t_{RF}.

In some embodiments, the method 900 may further include storing the estimated error in a profile associated with the target wireless device.

In some embodiments, the method 900 may further include: measuring a round trip time to a second target wireless device based on a first wireless signal sent to the second target wireless device and a second wireless signal received from the second target wireless device; estimating an error associated with the round trip time to the second target wireless device based on the round trip time to the second target wireless device and the round trip time to the reference object; and storing the estimated error associated with the round trip time to the second target wireless device in a profile associated with the second target wireless device.

Means for performing functionality at block 950 may comprise processor(s) 1110 and/or other components of a device, such as a UE, as illustrated in FIG. 11.

At block 960, the method 900 may include calibrating the measuring of the round trip time to the target wireless device using the estimated error. In some embodiments, the calibrating may include removing the estimated error from a round trip time measurement to the target wireless device based on the first wireless signal and the second wireless signal.

Means for performing functionality at block 960 may comprise processor(s) 1110 and/or other components of a device, such as a UE, as illustrated in FIG. 11.

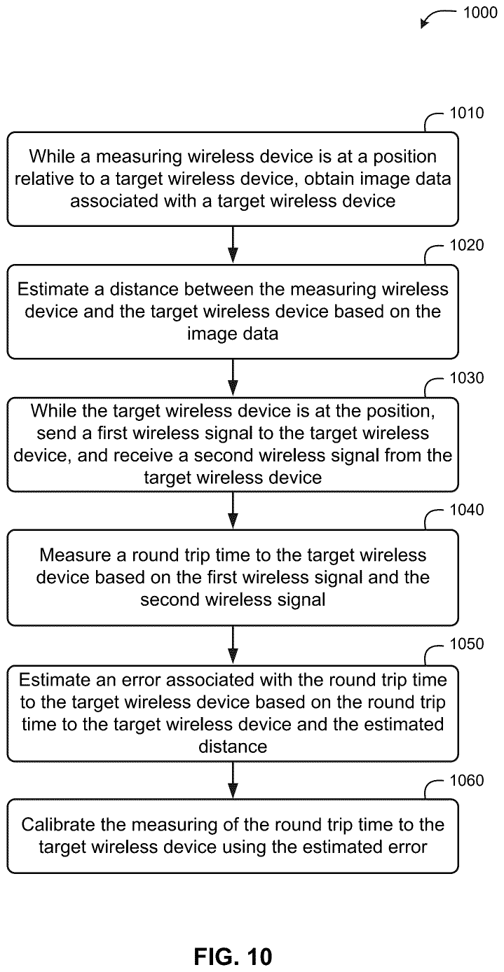

FIG. 10 is a flow diagram of a method 1000 of calibrating distance estimation with a target wireless device using a measuring wireless device, according to some embodiments. Structure for performing the functionality illustrated in one or more of the blocks shown in FIG. 10 may include hardware and/or software components of a wireless device, such as, for example, a controller apparatus, a computerized system, or a computer-readable apparatus including a storage medium storing computer-readable and/or computer-executable instructions that are configured to, when executed by at least one processor apparatus, cause the at least one processor apparatus or the network node to perform the operations. Example components of a device (e.g., UE) are illustrated FIG. 11, which is described in more detail below.

It should also be noted that the operations of FIG. 10 may be performed in any suitable order, not necessarily the order depicted in FIG. 10. Further, the process shown in FIG. 10 may include additional or fewer operations than those depicted in FIG. 10.

At block 1010, the method 1000 may include, while the measuring wireless device is at a position relative to the target wireless device, obtaining image data associated with a target wireless device. In some embodiments, the obtaining of the image data may include capturing one or more images via a camera of the measuring wireless device.

At block 1020, the method 1000 may include estimating a distance between the measuring wireless device and the target wireless device based on the image data. For example, image processing, depth tracking, pixel analysis, or a combination thereof. In some cases, a machine learning model may be used to estimate the distance between the measuring wireless device and the target wireless device based on the image data.

At block 1030, the method 1000 may include, while the target wireless device is at the position, sending a first wireless signal to the target wireless device, and receive a second wireless signal from the target wireless device.

At block 1040, the method 1000 may include measuring a round trip time to the target wireless device based on the first wireless signal and the second wireless signal.

At block 1050, the method 1000 may include estimating an error associated with the round trip time to the target wireless device based at least on the round trip time to the target wireless device.

At block 1060, the method 1000 may include calibrating the measuring of the round trip time to the target wireless device using the estimated error.

Blocks 1030-1060 may be examples of blocks 810-840 and may include similar functionalities, and descriptions therefor are omitted for brevity.

### Apparatus

FIG. 11 is a block diagram of an embodiment of a UE 105, which can be utilized as described herein above (e.g., in association with FIGS. 4-10) . For example, the UE 105 can perform one or more of the functions of the method shown in FIGS. 8-10. It should be noted that FIG. 11 is meant only to provide a generalized illustration of various components, any or all of which may be utilized as appropriate. It can be noted that, in some instances, components illustrated by FIG. 11 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 11.

The UE 105 is shown comprising hardware elements that can be electrically coupled via a bus 1105 (or may otherwise be in communication, as appropriate). The hardware elements may include a processor(s) 1110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below). The UE 105 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The UE 105 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1130 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

Depending on desired functionality, the wireless communication interface 1130 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2 ). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), infrared sensor(s), RF sensor(s), barometer(s), and the like), some of which may be used to obtain position-related measurements and/or other information. In some configurations, the sensor(s) 1140 may not be co-located with the UE 105, e.g., communicatively coupled (wired or wirelessly) but not disposed at the UE 105.

Embodiments of the UE 105 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1180 is illustrated in FIG. 11 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1110, DSP 1120, and/or a processor within the wireless communication interface 1130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1110 or DSP 1120.

The UE 105 may further include and/or be in communication with a memory 1160. The memory 1160 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the UE 105 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the UE 105 (and/or processor(s) 1110 or DSP 1120 within UE 105). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media or non-transitory computer-readable apparatus. The term “machine-readable medium” and “computer-readable medium” and “storage medium” as used herein, may refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of calibrating distance estimation with a target wireless device using a measuring wireless device, the method comprising: while the target wireless device is determined to be at a fixed position relative to the measuring wireless device based on a user calibration request at the measuring wireless device, inertial data of the measuring wireless device, sensed indication of the target wireless device, or a combination thereof, sending a first wireless signal to the target wireless device, and receiving a second wireless signal from the target wireless device; measuring a round trip time to the target wireless device based on the first wireless signal and the second wireless signal; estimating an error associated with the round trip time to the target wireless device based at least on the round trip time to the target wireless device; and calibrating the measuring of the round trip time to the target wireless device using the estimated error.

Clause 2. The method of clause 1, further comprising: while the target wireless device is at the position, sending a first radio frequency (RF) signal to a reference object proximate the target wireless device, and receiving a second RF signal reflected from the reference object; and measuring a round trip time to the reference object based on the first RF signal and the second RF signal; wherein the estimating of the error associated with the round trip time to the target wireless device comprises determining a difference between the round trip time to the target wireless device and the round trip time to the reference object.

Clause 3. The method of clause 2, wherein the estimating of the error comprises subtracting the round trip time to the reference object based on the first RF signal and the second RF signal from the round trip time to the target wireless device based on the first wireless signal and the second wireless signal.

Clause 4. The method of clause 2, further comprising: measuring a round trip time to a second target wireless device based on a first wireless signal sent to the second target wireless device and a second wireless signal received from the second target wireless device; estimating an error associated with the round trip time to the second target wireless device based on the round trip time to the second target wireless device and the round trip time to the reference object; and storing the estimated error associated with the round trip time to the second target wireless device in a profile associated with the second target wireless device.

Clause 5. The method of clause 2, wherein: the reference object comprises a surface against which the target wireless device is disposed; the first RF signal is sent and the second RF signal is received while the target wireless device is stationary against the surface; and the first RF signal is sent from measuring wireless device and the second RF signal is received at the measuring wireless device to perform monostatic RF sensing with a portion of the surface, the surface being proximate the target wireless device.

Clause 6. The method of clause 1, wherein the position of the target wireless device relative to the measuring wireless device comprises a position of the target wireless device having a vertical distance substantially equal to a vertical distance of a position of the measuring wireless device.

Clause 7. The method of clause 1, wherein the calibrating comprises removing the estimated error from a round trip time measurement to the target wireless device based on the first wireless signal and the second wireless signal.

Clause 8. The method of clause 1, wherein: the first wireless signal comprises a Wi-Fi signal sent to the target wireless device; and the second wireless signal comprises a Wi-Fi signal received from the target wireless device in response to the Wi-Fi signal sent to the target wireless device.

Clause 9. The method of clause 1, further comprising storing the estimated error in a profile associated with the target wireless device.

Clause 10. The method of clause 1, wherein the position of the target wireless device relative to the measuring wireless device comprises a position of the target wireless device which has a known distance to a position of the measuring wireless device.

Clause 11. The method of clause 1, further comprising: while the measuring wireless device is at the position relative to the target wireless device, obtaining image data associated with the target wireless device using a camera of the measuring wireless device; and estimating a distance between the measuring wireless device and the target wireless device based on the image data; wherein the position of the target wireless device relative to the measuring wireless device is based on a user-guided placement of the measuring wireless device within a field of view of the camera of the measuring wireless device.

Clause 12. A non-transitory computer-readable apparatus comprising a storage medium, the storage medium comprising a plurality of instructions configured to, when executed by one or more processors, cause a measuring wireless device to: while a target wireless device is determined to be at a fixed position relative to the measuring wireless device based on a user calibration request at the measuring wireless device, inertial data of the measuring wireless device, sensed indication of the target wireless device, or a combination thereof, send a first wireless signal to the target wireless device, and receive a second wireless signal from the target wireless device; measure a round trip time to the target wireless device based on the first wireless signal and the second wireless signal; estimate an error associated with the round trip time to the target wireless device based at least on the round trip time to the target wireless device; and calibrate the measurement of the round trip time to the target wireless device using the estimated error.

Clause 13. The non-transitory computer-readable apparatus of clause 12, wherein the plurality of instructions are further configured to, when executed by the one or more processors, cause the measuring wireless device to: while the target wireless device is at the position, sending a first radio frequency (RF) signal to a reference object proximate the target wireless device, and receiving a second RF signal reflected from the reference object; and measuring a round trip time to the reference object based on the first RF signal and the second RF signal; wherein the estimating of the error associated with the round trip time to the target wireless device is further based on a difference between the round trip time to the target wireless device and the round trip time to the reference object.

Clause 14. The non-transitory computer-readable apparatus of clause 13, wherein: the first wireless signal comprises a Wi-Fi signal sent to the target wireless device; and the second wireless signal comprises a Wi-Fi signal received from the target wireless device in response to the Wi-Fi signal sent to the target wireless device.

Clause 15. The non-transitory computer-readable apparatus of clause 13, wherein: the position of the target wireless device relative to the measuring wireless device comprises a position of the target wireless device having a vertical distance substantially equal to a vertical distance of a position of the measuring wireless device; the reference object comprises a surface against which the target wireless device is disposed; the first RF signal is sent and the second RF signal is received while the target wireless device is stationary against the surface; and the first RF signal is sent from measuring wireless device and the second RF signal is received at the measuring wireless device to perform monostatic RF sensing with a portion of the surface, the surface being proximate the target wireless device.

Clause 16. The non-transitory computer-readable apparatus of clause 12, wherein the position of the target wireless device relative to the measuring wireless device comprises a position of the target wireless device which has a known distance to a position of the measuring wireless device.

Clause 17. The non-transitory computer-readable apparatus of clause 12, wherein the plurality of instructions are further configured to, when executed by the one or more processors, cause the measuring wireless device to: while the measuring wireless device is at the position relative to the target wireless device, obtaining image data associated with the target wireless device using a camera of the measuring wireless device; and estimating a distance between the measuring wireless device and the target wireless device based on the image data; wherein the position of the target wireless device relative to the measuring wireless device is based on a user-guided placement of the measuring wireless device within a field of view of the camera of the measuring wireless device.

Clause 18. A wireless device comprising: one or more transceivers; one or more memories; and one or more processors communicatively coupled with the one or more transceivers and the one or more memories, wherein the one or more processors are configured to: while a target wireless device is determined to be at a fixed position relative to the wireless device based on a user calibration request at the wireless device, inertial data of the wireless device, sensed indication of the target wireless device, or a combination thereof, send a first

wireless signal to the target wireless device, and receive a second wireless signal from the target wireless device; measure a round trip time to the target wireless device based on the first wireless signal and the second wireless signal; estimate an error associated with the round trip time to the target wireless device based at least on the round trip time to the target wireless device; and calibrate the measurement of the round trip time to the target wireless device using the estimated error.

Clause 19. The wireless device of clause 18, wherein the one or more processors are further configured to: while the target wireless device is at the position, send a first radio frequency (RF) signal to a reference object proximate the target wireless device, and receive a second RF signal reflected from the reference object; and measure a round trip time to the reference object based on the first RF signal and the second RF signal; wherein the estimation of the error associated with the round trip time to the target wireless device is further based on a difference between the round trip time to the target wireless device and the round trip time to the reference object.

Clause 20. The wireless device of clause 19, wherein: the one or more transceivers comprise a first transceiver and a second transceiver; the first transceiver comprises a radio frequency (RF) transceiver configured to send the first RF signal to the reference object and receive the second RF signal; and the second transceiver comprises a Wi-Fi transceiver configured to send the first wireless signal to the target wireless device and receive the second wireless signal.

What is claimed is:

1. A method of calibrating distance estimation with a target wireless device using a measuring wireless device, the method comprising:
while the target wireless device is determined to be at a fixed position relative to the measuring wireless device based on a user calibration request at the measuring wireless device, inertial data of the measuring wireless device, sensed indication of the target wireless device, or a combination thereof, sending a first wireless signal to the target wireless device, and receiving a second wireless signal from the target wireless device;
measuring a round trip time to the target wireless device based on the first wireless signal and the second wireless signal;
estimating an error associated with the round trip time to the target wireless device based at least on the round trip time to the target wireless device; and
calibrating the measuring of the round trip time to the target wireless device using the estimated error.

2. The method of claim 1, further comprising:
while the target wireless device is at the position, sending a first radio frequency (RF) signal to a reference object proximate the target wireless device, and receiving a second RF signal reflected from the reference object; and
measuring a round trip time to the reference object based on the first RF signal and the second RF signal;
wherein the estimating of the error associated with the round trip time to the target wireless device comprises determining a difference between the round trip time to the target wireless device and the round trip time to the reference object.

3. The method of claim 2, wherein the estimating of the error comprises subtracting the round trip time to the reference object based on the first RF signal and the second RF signal from the round trip time to the target wireless device based on the first wireless signal and the second wireless signal.

4. The method of claim 2, further comprising:
measuring a round trip time to a second target wireless device based on a first wireless signal sent to the second target wireless device and a second wireless signal received from the second target wireless device;
estimating an error associated with the round trip time to the second target wireless device based on the round trip time to the second target wireless device and the round trip time to the reference object; and
storing the estimated error associated with the round trip time to the second target wireless device in a profile associated with the second target wireless device.

5. The method of claim 2, wherein:
the reference object comprises a surface against which the target wireless device is disposed;
the first RF signal is sent and the second RF signal is received while the target wireless device is stationary against the surface; and
the first RF signal is sent from measuring wireless device and the second RF signal is received at the measuring wireless device to perform monostatic RF sensing with a portion of the surface, the surface being proximate the target wireless device.

6. The method of claim 1, wherein the position of the target wireless device relative to the measuring wireless device comprises a position of the target wireless device having a vertical distance substantially equal to a vertical distance of a position of the measuring wireless device.

7. The method of claim 1, wherein the calibrating comprises removing the estimated error from a round trip time measurement to the target wireless device based on the first wireless signal and the second wireless signal.

8. The method of claim 1, wherein:
the first wireless signal comprises a Wi-Fi signal sent to the target wireless device; and
the second wireless signal comprises a Wi-Fi signal received from the target wireless device in response to the Wi-Fi signal sent to the target wireless device.

9. The method of claim 1, further comprising storing the estimated error in a profile associated with the target wireless device.

10. The method of claim 1, wherein the position of the target wireless device relative to the measuring wireless device comprises a position of the target wireless device which has a known distance to a position of the measuring wireless device.

11. The method of claim 1, further comprising:
while the measuring wireless device is at the position relative to the target wireless device, obtaining image data associated with the target wireless device using a camera of the measuring wireless device; and
estimating a distance between the measuring wireless device and the target wireless device based on the image data;
wherein the position of the target wireless device relative to the measuring wireless device is based on a user-guided placement of the measuring wireless device within a field of view of the camera of the measuring wireless device.

12. A non-transitory computer-readable apparatus comprising a storage medium, the storage medium comprising a plurality of instructions configured to, when executed by one or more processors, cause a measuring wireless device to:
while a target wireless device is determined to be at a fixed position relative to the measuring wireless device based on a user calibration request at the measuring wireless device, inertial data of the measuring wireless device, sensed indication of the target wireless device, or a combination thereof, send a first wireless signal to the target wireless device, and receive a second wireless signal from the target wireless device;
measure a round trip time to the target wireless device based on the first wireless signal and the second wireless signal;
estimate an error associated with the round trip time to the target wireless device based at least on the round trip time to the target wireless device; and
calibrate the measurement of the round trip time to the target wireless device using the estimated error.

13. The non-transitory computer-readable apparatus of claim 12, wherein the plurality of instructions are further configured to, when executed by the one or more processors, cause the measuring wireless device to:
while the target wireless device is at the position, sending a first radio frequency (RF) signal to a reference object proximate the target wireless device, and receiving a second RF signal reflected from the reference object; and
measuring a round trip time to the reference object based on the first RF signal and the second RF signal;
wherein the estimating of the error associated with the round trip time to the target wireless device is further based on a difference between the round trip time to the target wireless device and the round trip time to the reference object.

14. The non-transitory computer-readable apparatus of claim 13, wherein:
the first wireless signal comprises a Wi-Fi signal sent to the target wireless device; and
the second wireless signal comprises a Wi-Fi signal received from the target wireless device in response to the Wi-Fi signal sent to the target wireless device.

15. The non-transitory computer-readable apparatus of claim 13, wherein:
the position of the target wireless device relative to the measuring wireless device comprises a position of the target wireless device having a vertical distance substantially equal to a vertical distance of a position of the measuring wireless device;
the reference object comprises a surface against which the target wireless device is disposed;
the first RF signal is sent and the second RF signal is received while the target wireless device is stationary against the surface; and
the first RF signal is sent from measuring wireless device and the second RF signal is received at the measuring wireless device to perform monostatic RF sensing with a portion of the surface, the surface being proximate the target wireless device.

16. The non-transitory computer-readable apparatus of claim 12, wherein the position of the target wireless device relative to the measuring wireless device comprises a position of the target wireless device which has a known distance to a position of the measuring wireless device.

17. The non-transitory computer-readable apparatus of claim 12, wherein the plurality of instructions are further configured to, when executed by the one or more processors, cause the measuring wireless device to:
while the measuring wireless device is at the position relative to the target wireless device, obtaining image data associated with the target wireless device using a camera of the measuring wireless device; and
estimating a distance between the measuring wireless device and the target wireless device based on the image data;
wherein the position of the target wireless device relative to the measuring wireless device is based on a user-guided placement of the measuring wireless device within a field of view of the camera of the measuring wireless device.

18. A wireless device comprising:
one or more transceivers;
one or more memories; and
one or more processors communicatively coupled with the one or more transceivers and the one or more memories, wherein the one or more processors are configured to:
while a target wireless device is determined to be at a fixed position relative to the wireless device based on a user calibration request at the wireless device, inertial data of the wireless device, sensed indication of the target wireless device, or a combination thereof, send a first wireless signal to the target wireless device, and receive a second wireless signal from the target wireless device;
measure a round trip time to the target wireless device based on the first wireless signal and the second wireless signal;
estimate an error associated with the round trip time to the target wireless device based at least on the round trip time to the target wireless device; and
calibrate the measurement of the round trip time to the target wireless device using the estimated error.

19. The wireless device of claim 18, wherein the one or more processors are further configured to:
while the target wireless device is at the position, send a first radio frequency (RF) signal to a reference object proximate the target wireless device, and receive a second RF signal reflected from the reference object; and
measure a round trip time to the reference object based on the first RF signal and the second RF signal;
wherein the estimation of the error associated with the round trip time to the target wireless device is further based on a difference between the round trip time to the target wireless device and the round trip time to the reference object.

20. The wireless device of claim 19, wherein:
the one or more transceivers comprise a first transceiver and a second transceiver;
the first transceiver comprises a radio frequency (RF) transceiver configured to send the first RF signal to the reference object and receive the second RF signal; and
the second transceiver comprises a Wi-Fi transceiver configured to send the first wireless signal to the target wireless device and receive the second wireless signal.
